(19) United States
(12) Patent Application Publication
(10) Pub. No.: US 2006/0082997 A1
(43) Pub. Date: Apr. 20, 2006

(54) Illumination device

(76) Inventors: Olivier Derrien, St Mesmin (FR); Jerome Monnot, Menestreau En Villette (FR)

Correspondence Address: YOUNG & THOMPSON, 745 SOUTH 23RD STREET, 2ND FLOOR, ARLINGTON, VA, 22202, US

(21) Appl. No.: 10/543,608

(22) PCT Filed: Jan. 30, 2004
(86) PCT No.: PCT/FR04/00215

§ 371 Date: Jul. 28, 2005

(30) Foreign Application Priority Data
Feb. 6, 2003 (FR) 03/01419

(51) Int. Cl. F21V 1/00

(52) U.S. Cl. 362/236

(57) ABSTRACT

A lighting device is adapted to light an area of lighting (4) and includes a lighting support (6) having a bell (12), a first light source (20), and a second light source (40) distinct from the first light source (20). The light source (20) is disposed on the same side of the bell (12) as the first light source (20). The lighting device (10) has an enlarging optical element (44) adapted to enlarge a light beam emitted towards the area of lighting (4) by the second light source (40), and interposed between the second light source (40) and the area of lighting (4). The lighting device is suitable for use in operating theaters.

The present invention relates to a lighting device as defined in the precharacterizing portion of claim 1.

The invention applies in particular to devices for lighting an operating field in an operating theater.

Document U.S. Pat. No. US-B-5,539,626 describes a lighting device adapted for lighting an operative field. That lighting device comprises first and second lighting assemblies.

The first lighting assembly is adapted to light the operative field at high density over a lighting domain of relatively limited extent. It comprises a light source adapted to emit light directly towards the operative field. By way of example, the first lighting assembly is used when introducing endoscopes into the body of a patient.

The second lighting assembly is adapted to light the operative field and the surroundings of the operative field with diffuse light of lower intensity than that created by the first assembly. The second lighting assembly comprises two lamps organized to emit light towards the ceiling of the operating theater. Consequently, the operative field is lighted only indirectly by the second assembly.

The second lighting assembly is used, for example, after endoscopes have been introduced, in order to match the surgery on observation monitor screens.

The lighting device also comprises selector means adapted to select either the first or the second lighting assembly in alternation.

A drawback of that lighting device lies in the fact that for a given level of diffuse lighting of the operative field by the second assembly, the power required from the two lamps is relatively high.

Furthermore, the diffuse lighting depends on the properties of the material constituting the ceiling and therefore cannot be predetermined when building the lighting device.

An object of the invention is to remedy those drawbacks and to propose a lighting device which enables the operative field to be lighted in diffuse and predetermined manner with relatively low energy consumption.

For this purpose, the invention provides a lighting device of the above-specified type, characterized by the characteristics of the characterizing portion of claim 1.

In other embodiments, the invention includes one or more of the characteristics of the dependent claims.

The invention will be better understood on reading the following description given purely by way of example and made with reference to the accompanying drawings, in which:

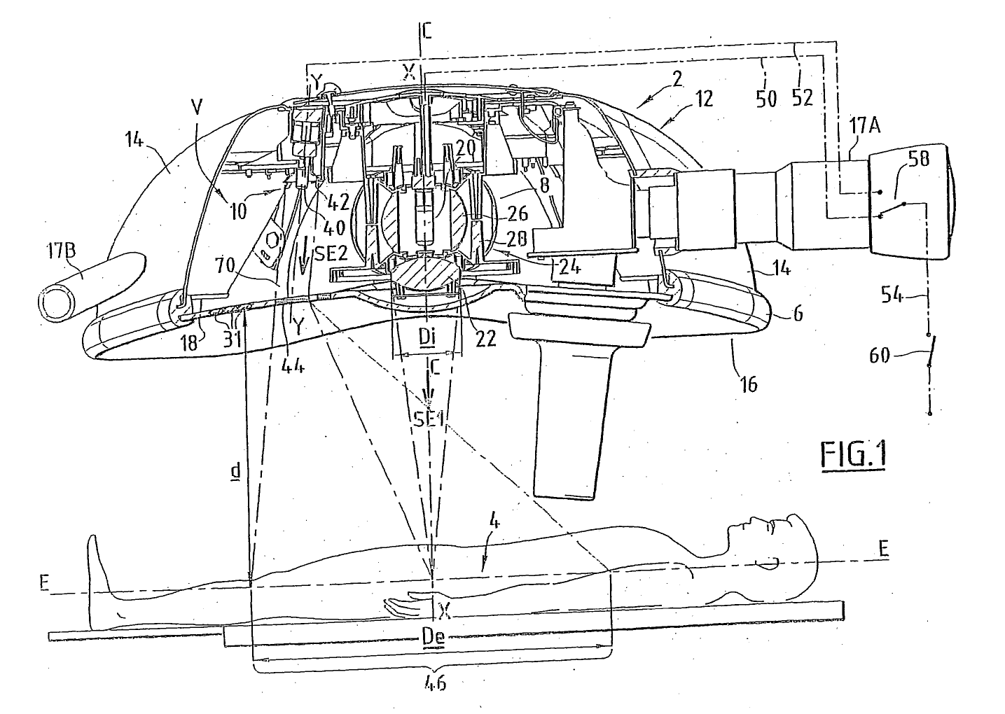

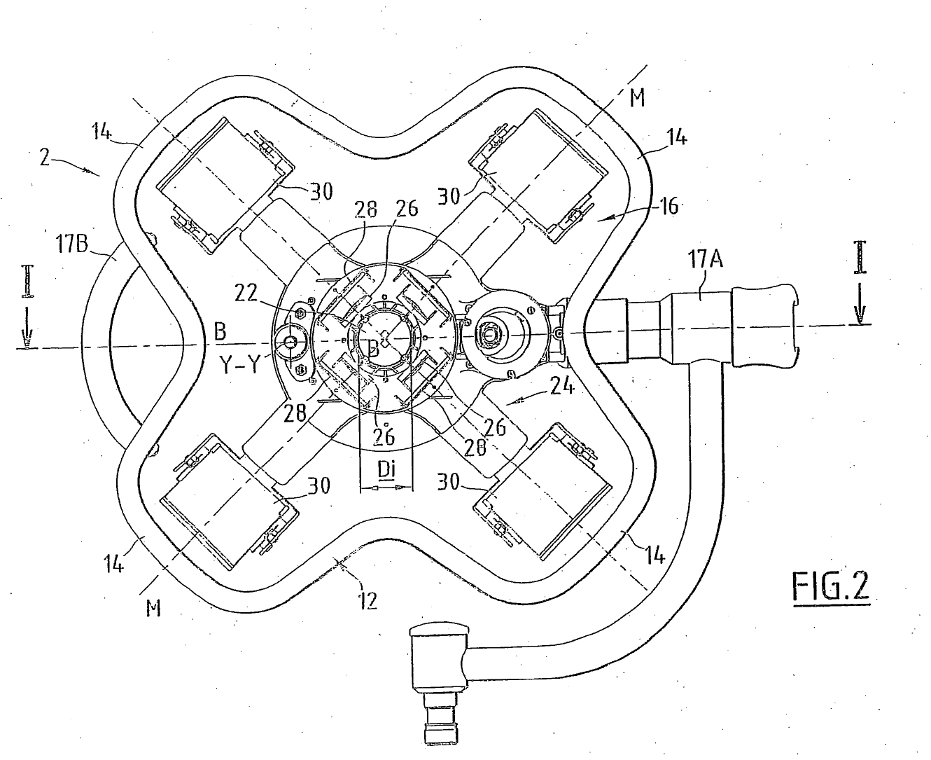

FIG. 1 is a side view in section on line I-I of FIG. 2 through a lighting device constituting a first embodiment of the invention;

FIG. 2 is a view from beneath of the first embodiment of the lighting device of the invention;

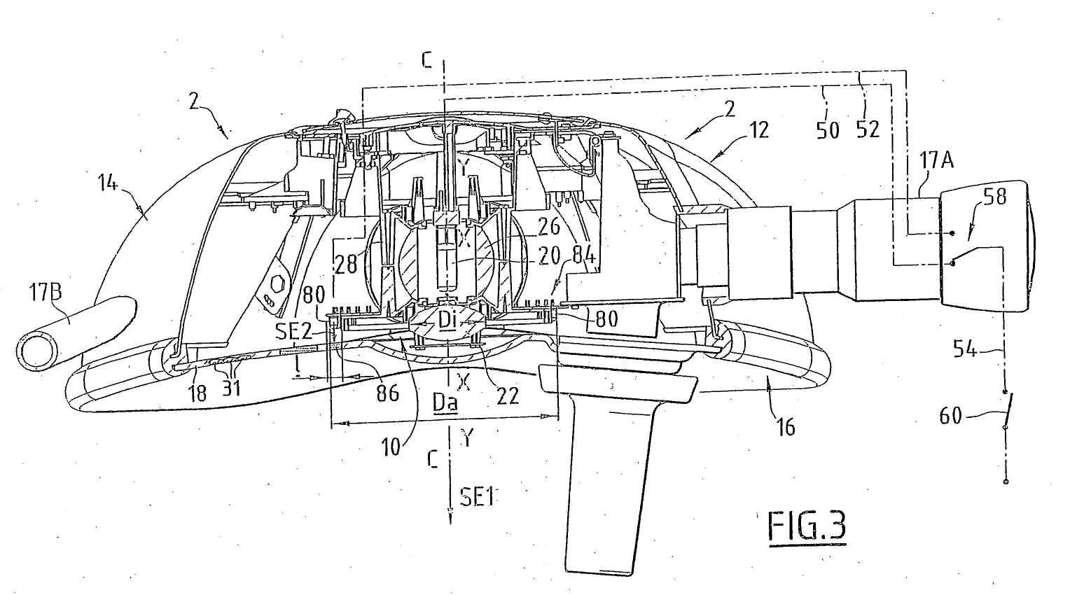

FIG. 3 is a view of a second embodiment of the device of the invention, the view being identical to that of FIG. 1; and

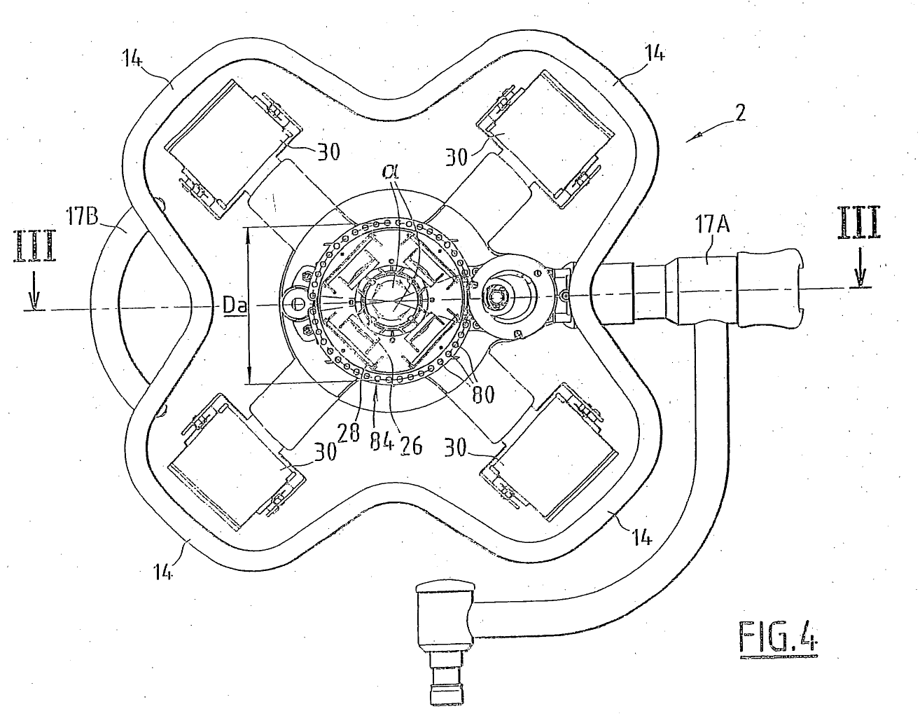

FIG. 4 is a view from beneath of the FIG. 3 device.

FIG. 1 shows a first embodiment of a lighting device in an operating theater, given overall reference 2.

The lighting device 2 is adapted to light an area of lighting 4, e.g. a surgeon's operative field on a patient. The area of lighting 4 extends in a lighting plane E-E that is substantially horizontal.

The lighting device 2 comprises a housing 6 and first and second lighting assemblies 8 and 10 disposed over the area of lighting 4. The housing 6 defines a central axis C-C extending substantially perpendicularly to the lighting plane E-E.

The housing 6 forms a lighting support for the first and second lighting assemblies 8 and 10.

It comprises an opaque four-lobe bell 12 having four lobes 14. The four lobes 14 lie in the same plane and project radially relative to the central axis C-C. The bell 12 is substantially closed on its side remote from the area of lighting 4 and it defines an opening 16 on its side facing towards the area of lighting 4. The bell 12 is also provided with two handles 17A and 17B.

The housing 6 also comprises a substantially transparent closure plate 18 which closes the opening 16 of the bell 12.

The bell 12 and the closure plate enclose an inside volume V.

Each lobe 14 extends along one of two midplanes M-M which extend radially from the central axis C-C and perpendicularly to each other (FIG. 2).

The first lighting assembly 8 defines a first lighting axis X-X coinciding with the central axis C-C. This lighting assembly 8 comprises a bulb 20, a central lens 22 of a diameter Dᵢ, and four identical filter-and-mirror groups 24.

The bulb 20 is disposed in the inside volume of the bell and is of nominal power lying in the range 100 watts (W) to 150 W.

Each filter-and-mirror group 24 is constituted by two side lenses 26 and 28 disposed parallel to the lighting axis X-X, a mirror 30, and a multitude of focusing microlenses 31 secured to the closure plate 18. The side lenses 26 and 28 and the mirror 30 of each group 24 are disposed relative to one another in positions along one of the midplanes M-M going radially from the central axis C-C in one of the lobes 14.

The mirror 30 is adapted to reflect a fraction of the light emitted by the bulb 20 towards the microlenses 31.

The first lighting assembly 8 is adapted to light the area of lighting 4 in a first lighting direction SE1 extending from the housing 6 towards the area of lighting 4, and thus substantially vertically downwards in FIG. 1, along the axis X-X.

The second lighting assembly 10 comprises a second bulb 40, in particular an incandescent bulb, disposed in a parabolic reflector 42 disposed within the inside volume of the bell 12, together with a member 44 of opal glass.

The nominal power of the second bulb 40 lies in the range 15 W to 25 W, and it is preferably 20 W.

Specifically, the member 44 of opal glass is constituted by a circular portion of opal glass secured to the closure plate 18. This member 44 of opal glass is disposed on the path of light rays emitted by the bulb 40 and the reflector 42, and it is adapted to enlarge the light beam emitted by the second bulb 40. Thus, the opal glass member 44 forms an optical enlarging element.

The second bulb 40, the reflector 42, and the optical member 44 lie on a common axis extending along a second lighting axis Y-Y. The lighting axis Y-Y is advantageously disposed in a plane B-B that bisects the two midplanes M-M (FIG. 2). Between them, the two axes X-X and Y-Y define an angle lying in the range 0° to 10°, and preferably equal to 6°.

Thus, the second lighting assembly 10 is adapted to emit light in a second lighting direction SE2 going from the bulb 40 towards the area of lighting 4. In general, the direction SE2 has a component directed in the same direction as SE1.

The multitude of microlenses 31 and the optical member 44 extend at a distance d from the area of lighting 4. This distance d lies in the range 0.8 meters (m) to 1.60 m.

The first lighting assembly 8 is adapted to illuminate the area of lighting 4 over a lighting domain 46 at a first level of illumination, greater than 50,000 lux and preferably greater than 70,000 lux when the distance d is one meter. The lighting domain 46 has a diameter of one meter and it is centered on the axis C-C.

By means of the bulb 40 and the member 44, the second lighting assembly 10 is adapted to illuminate the lighting domain 46 from a distance d of one meter with a level of illumination lying in the range 50 lux to 150 lux, and preferably lying in the range 75 lux to 125 lux.

The first lighting assembly 8 further comprises a first power supply line 50 connected to the first bulb 20, and the second lighting assembly 10 further comprises a second power supply line 52 connected to the second bulb 40.

The device 2 is further provided with a main power supply line 54 and means for selecting the first or the second lighting assembly 8 or 10. These selector means comprise a changeover switch 58 disposed in the handle 17A. The changeover switch 58 is connected to the main power supply line 54 and enables the main power supply line 54 to be connected alternately to the first or the second power supply line 50 or 52.

The lighting device 2 further comprises a main ON/OFF switch 60 interposed in the main power supply line 54 and enabling the supply of power to the lighting device 2 to be switched ON and OFF.

The fact that the closure plate 18, the microlenses 31, and the portion 44 made of opal glass are manufactured as a single part, makes it easier to assemble the lighting device.

The lighting device of the invention operates as follows.

Initially, the main switch 60 is in its OFF position, so no electricity is fed to the device 2.

The changeover switch 58 is in a first position in which it connects the main power supply line 54 to the first power supply line 50.

When the surgeon seeks to illuminate the area of lighting 4 at high intensity, i.e. a high level of illumination, e.g. 70,000 lux, the surgeon operates the main switch 60. The first lighting assembly 8 is thus powered electrically and the first bulb 20 emits light. A first portion of the light it emits is focused by the central lens 22 onto the lighting domain 46. A second portion of the light emitted by the first bulb 20 passes through the side lenses 26 and 28 and is reflected by the mirrors 30. The portion of the light reflected by the mirrors 30 is focused by the microlenses 31 onto the lighting domain 46.

When the surgeon needs to have dimmer lighting in the lighting domain 46, the surgeon operates the changeover switch 58.

Consequently, the second power supply line 52 is powered electrically while the first power supply line 50 is no longer powered. The second bulb 40 then emits light which is guided by the reflector 42 so as to form a beam 70. The beam 70 is directed towards the opal glass portion 44 of the closure plate 18 and is enlarged by said portion. The area of lighting 4, and in particular the lighting domain 46, is thus illuminated by a diffuse beam of light of lower intensity than that from the first lighting assembly.

At least a fraction of the light emitted by the second bulb 40 travels along the entire path between the second bulb 40 and the area of lighting 4 in the direction SE2. By virtue of this characteristic, the distance traveled by the light between the second bulb 40 and the area of lighting 4 is relatively short and, as a result, the low power of the second bulb 40 suffices for achieving a given level of illumination in the area of lighting 4.

It should be observed that the illumination created by the second lighting assembly 10 is of the same order of magnitude as the brightness of an observation monitor screen for watching when taking action with an endoscope.

FIGS. 3 and 4 show a lighting device 2 constituting a second embodiment of the invention.

Only the differences relative to the first embodiment are described below. Elements that are analogous are given the same references.

The second lighting assembly 10 includes a plurality of light-emitting diodes 80 (LEDs). These LEDs 80 are disposed around a base circle 82 of diameter Dₐ forming two segments of a ring 84 extending around the lighting axis Y-Y.

Each segment occupies an angle α of at least 90° and preferably of at least 150°.

The ring 84 is substantially coplanar with the central lens 22.

The lighting direction SE2 is the direction in which light is emitted from each of the LEDs 80. It extends parallel to the axis Y-Y towards the area of lighting 4. The diameter Dₐ of the base circle is greater than the diameter Dᵢ of the central lens 22 of the first lighting assembly 8 so that the LEDs 80 are disposed outside the path followed by light rays from the first lighting assembly 8.

The enlarging optical member is formed by a ring segment 86 of opal glass disposed in the closure plate 18 and occupying an angle that is not less than the sum of the angles α.

The ring segment 86 has a base circle of diameter Dₐ and a width 1 which is greater than the diameter of the light-emitting diodes 80.

By using LEDs 80, the second lighting assembly 10 has particularly low electricity consumption and long lifetime.

The lighting device 2 of the invention enables the area of lighting 4 to be illuminated in diffuse light while consuming little energy.

All of the optical components situated on the paths of the rays from the light sources to the area of lighting are carried by the housing 6. Consequently, the lighting properties of the device can be predetermined and depend little on the surroundings.

In general, the intensity of illumination of the first lighting assembly is much greater than that of the second lighting assembly. The illumination of the first lighting assembly is at least 10,000 lux greater than that of the second lighting assembly. Preferably, it is at least 25,000 lux greater, and in particular 35,000 lux greater.

1. A lighting device adapted to illuminate an area of lighting (4), the device being of the type comprising:
a lighting support (6) having a bell (12);
a first lighting assembly (8) which is carried by the lighting support (6), comprising a first light source (20) disposed facing the area of lighting (4) and adapted to illuminate a lighting domain (46) in the area of lighting (4) with a first intensity and in a first lighting direction (SE1) extending from the lighting support (6) towards the area of lighting (4); and
a second lighting assembly (10) carried by the lighting support (6), comprising a second light source (40; 80) distinct from the first light source (20) and adapted to illuminate the lighting domain (46) with a second intensity and along a second lighting direction (SE2);
the device being characterized in that said second light source (20) is disposed on the same side of the bell (12) as said first light source (20), in that said second lighting assembly (10) includes an enlarging optical element (44; 86) adapted to enlarge a light beam emitted towards the area of lighting (4) by said second light source (40; 80), which enlarging optical element is carried by the support (6) and is interposed between the second light source (40; 80) and the area of lighting (4), in that said second lighting direction (SE2) has a component parallel to said first lighting direction (SE1) with light traveling in the same direction therealong, and in that at least a fraction of the light emitted by said second light source (40; 80) travels along the entire path along said second lighting direction (SE2).

2. A lighting device according to claim 1, characterized in that the bell (12) defines an inside volume (V), and in that said first and second light sources (20 and 40; 80) are disposed within the inside volume (V).

3. A lighting device according to claim 1, characterized in that the bell (12) is made of opaque material.

4. A lighting device according to claim 1, characterized in that said first lighting assembly (8) is adapted to illuminate the lighting domain (46) when it is situated at a distance d of 1 m from said enlarging optical element (44; 86) at a first level of illumination, and in that the lighting domain (46) has a diameter of 1 m.

5. A lighting device according to claim 4, characterized in that the first level of illumination is greater than 50,000 lux, and preferably greater than 70,000 lux.

6. A lighting device according to claim 4, characterized in that said first lighting assembly (8) defines a first lighting axis (X-X) and includes a first focusing optical element (22) adapted to focus a fraction of the light emitted by said first light source (20) onto the area of lighting (4), in that said first light source comprises a first bulb (20), and in that said first bulb (20) and said first focusing optical element (22) are disposed on said first lighting axis (X-X).

7. A lighting device according to claim 6, characterized in that said first focusing optical element is an optical lens (22).

8. A lighting device according to claim 1, characterized in that the enlarging optical element comprises a member (44; 86) made of opal glass.

9. A lighting device according to claim 1, characterized in that the support (6) includes a transparent closure plate (18) disposed between said first light source (20) and the area of lighting (4) and also between said second light source (40; 80) and the area of lighting (4), and in that the closure plate (18) is provided with the enlarging optical element (44, 86).

10. A lighting device according to claim 9, characterized in that said first lighting assembly (8) includes a second focusing optical element (31), in particular a multitude of microlenses, and in that said second focusing optical element (31) is carried by the closure plate (18).

11. A lighting device according to claim 10, characterized in that the closure plate (18), said second focusing optical element (31), and the enlarging optical element (44, 86) are constituted by a single part.

12. A lighting device according to claim 1, characterized in that said second light source comprises a bulb (40) in particular an incandescent bulb, and preferably a bulb having nominal power lying in the range 15 W to 25 W, and in particular equal to 20 W.

13. A lighting device according to claim 12, characterized in that said second lighting assembly (10) comprises a reflector (42) and defines a second lighting axis (Y-Y) which is distinct from the first lighting axis (X-X).

14. A lighting device according to claim 1, characterized in that said second light source comprises a plurality of LEDs (80).

15. A lighting device according to claim 14, characterized in that each of the LEDs (80) has a light-emitting direction (SE2), and in that all of the light-emitting directions are parallel to one another.

16. A lighting device according to claim 14, characterized in that the plurality of LEDs (80) forms a ring (84) having a third lighting axis (Y-Y).

17. A lighting device according to claim 16,
wherein said first lighting assembly (8) is adapted to illuminate the lighting domain (46) when it is situated at a distance d of 1 m from said enlarging optical element (44; 86) at a first level of illumination, and in that the lighting domain (46) has a diameter of 1 m;
wherein said first lighting assembly (8) defines a first lighting axis (X-X) and includes a first focusing optical element (22) adapted to focus a fraction of the light emitted by said first light source (20) onto the area of lighting (4), in that said first light source comprises a first bulb (20), and in that said first bulb (20) and said first focusing optical element (22) are disposed on said first lighting axis (X-X); and
characterized in that the third lighting axis (Y-Y) coincides with said first lighting axis (X-X).

18. A lighting device according to claim 1, characterized in that said second lighting assembly (10) is adapted to illuminate the lighting domain (46) when it is situated at a distance of 1 m from said enlarging optical element (86) with a second level of illumination, and in that the diameter of the lighting domain (46) is 1 m.

19. A lighting device according at least to claim 18,
wherein said first lighting assembly (8) is adapted to illuminate the lighting domain (46) when it is situated at a distance d of 1 m from said enlarging optical element (44; 86) at a first level of illumination, and in that the lighting domain (46) has a diameter of 1 m;
characterized in that the first level of illumination is considerably greater than the second level of illumination.

20. A lighting device according to claim 19, characterized in that the first level of illumination is at least 10,000 lux greater than the second level of illumination.

21. A lighting device according to claim 20, characterized in that the first level of illumination is at least 25,000 lux, and preferably at least 35,000 lux, greater than the second level of illumination.

22. A lighting device according to claim 21, characterized in that the second level of illumination lies in the range 50 lux to 150 lux, and preferably lies in the range 75 lux to 125 lux.

23. A lighting device according to claim 1, characterized in that it includes selector means (58) adapted to power one or the other of said first and second lighting assemblies (8 or 10) in alternation.

24. A lighting device according to claim 1, characterized in that the lighting device (2) is a device for lighting an operative field (4) in an operating theater.
